(19) United States
(12) Patent Application Publication
(10) Pub. No.: US 2010/0082438 A1
(43) Pub. Date: Apr. 1, 2010

(54) METHODS AND SYSTEMS FOR CUSTOMER PERFORMANCE SCORING

(76) Inventor: Ronnie Jack Garmon, Marietta, GA (US)

Correspondence Address: SUTHERLAND ASBILL & BRENNAN LLP, 999 PEACHTREE STREET, N.E., ATLANTA, GA, 30309, US

(21) Appl. No.: 12/567,973

(22) Filed: Sep. 28, 2009

Related U.S. Application Data
(60) Provisional application No. 61/101,941, filed on Oct. 1, 2008.

(51) Int. Cl. G06Q 30/00

(52) U.S. Cl. 705/14.66

(57) ABSTRACT

Methods and systems for customer performance scoring are provided. In one embodiment a method and system for customer performance scoring can include receiving user identification information. Based at least in part on the user identification information, a customer performance score can be determined. Based at least in part on the customer performance score, an offer to extend to an online user can be determined.

### RELATED APPLICATION

This application claims priority to U.S. Provisional Ser. No. 61/104,941, entitled “Method for Customer Performance Scoring,” filed Oct. 13, 2008, the contents of which are hereby incorporated by reference.

### FIELD OF THE INVENTION

This invention relates generally to analyzing customer behavior and more specifically, to providing methods and systems for customer performance scoring.

### BACKGROUND OF THE INVENTION

The increase in Internet commerce traffic and resulting online transactions has created a need for tracking online customer behavior. Generally, tracking online customer behavior has been accomplished using “cookies”, which are strings of text sent from a web server to a client computer via the user's Internet browser program when the user accesses a website of interest. The user's client computer sends the cookies back to the web server each time the user visits the website of interest. Cookies have typically been used for authentication, session tracking, and conveying or maintaining certain information (personal and/or shopping cart) during a website visit. However, cookies have limited functionality in tracking online customer performance, and in some instances, may be rejected by users or their respective Internet browser application programs, which causes some websites to have limited functionality or use during the users' visits.

Accordingly, there is a need for methods and systems for analyzing online customer transactional behavior. Further, there is a need for methods and systems for customer performance scoring. There is also a need for methods and systems for providing an online offer based on a customer performance score. In addition, there is a need for methods and systems for determining a customer performance score.

### SUMMARY OF THE INVENTION

Some of all of the above needs can be addressed by certain embodiments of the invention. In one embodiment, a system and method can determine a customer performance score. In certain instances, combining all of the relevant information about a particular consumer into a single alphanumeric score can provide an improved understanding of the particular customer's performance relative to some or all other customers. The score, also known in at least one embodiment as a PowerVue™ score, can be a micro-level targeting tool allowing a user to offer a relatively high level of personalization for customers' online experiences resulting in increased customer loyalty and revenue.

According to one embodiment of the invention, there is disclosed a method and system for customer performance scoring. The method can include receiving user identification information. Based at least in part on the user identification information, a customer performance score can be determined. Based at least in part on the customer performance score, an offer to extend to an online user can be determined.

According to another embodiment of the invention, there is disclosed a method for determining a customer performance score. The method can include based at least in part on a persistence attribute, determining at least one persistence factor. Further, the method can include based at least in part on a value attribute, determining at least one value factor. In addition, the method can include based at least in part on the at least one persistence factor and the at least one value factor, determining a customer performance score indicative of a customer's performance relative to other customers.

According to yet another embodiment of the invention, a system for providing an online offer can be provided. The system can include a processor operable to receive user identification information; to determine a customer performance score based at least in part on the user identification information; and to determine an offer to extend to an online user based at least in part on the customer performance score.

According to yet another embodiment of the invention, a system for determining a customer performance score can be provided. The system can include a processor operable to determine at least one persistence factor based at least in part on a persistence attribute; to determine at least one value factor based at least in part on a value attribute; and to determine a customer performance score indicative of a customer's performance relative to other customers based at least in part on the at least one persistence factor and the at least one value factor.

According to another embodiment of the invention, a method for receiving an online offer can be provided. The method can include transmitting user identification information. The method can also include receiving an online offer based at least in part on a customer performance score, wherein the customer performance score comprises at least one persistence component and at least one value component, the at least one persistence component and at least one value component based at least in part on user identification information. Further, the method can include transmitting an acceptance or decline of the online offer.

Other embodiments, aspects, and features of the invention will become apparent from the following detailed description, the accompanying drawings, and the appended claims.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart illustrating one example method for customer performance scoring in accordance with an illustrative embodiment of the invention.

FIG. 2 is a flowchart illustrating one example method for providing an online offer in accordance with an illustrative embodiment of the invention.

FIG. 3 is a flowchart illustrating one example method for customer performance scoring and providing an online offer in accordance with an illustrative embodiment of the invention.

FIG. 4 is one example system according to an illustrative embodiment of the invention.

FIG. 5 is an example customer data record or file according to an illustrative embodiment of the invention.

FIG. 6 is an example attribute weighting table according to an illustrative embodiment of the invention.

FIG. 7 illustrates an example X and Y value computation according to an illustrative embodiment of the invention.

FIG. 8 illustrates an example score computation according to an illustrative embodiment of the invention.

FIG. 9 illustrates an example score distribution by block according to an illustrative embodiment of the invention.

FIG. 10 illustrates an example score implementation according to an illustrative embodiment of the invention.

FIG. 11 illustrates an example summary cross tab table according to an illustrative embodiment of the invention.

FIG. 12 illustrates an example score distribution according to an illustrative embodiment of the invention.

FIG. 13 illustrates another example score distribution according to an illustrative embodiment of the invention.

FIG. 14 illustrates another example score distribution according to an illustrative embodiment of the invention.

FIG. 15 is an example user interface for implementing a system and method in accordance with an illustrative embodiment of the invention.

### DETAILED DESCRIPTION OF EMBODIMENTS OF THE INVENTION

The terms “user”, “member”, “customer”, and their respective pluralized forms are used interchangeably throughout the specification, and are intended to identify a person interacting with a website or program associated with a customer performance scoring module and/or processor, and whose online behavior is of interest to the customer performance scoring module and/or processor. In certain instances, a “user” can be an administrative user who may be interested in the online behavior of other users interacting with a website or program associated with a customer performance scoring module and/or processor

The terms “user information”, “user identification information”, and “data” are used interchangeably throughout the specification, and are intended to identify any information associated with a user, member, or customer. Examples of such information can be used to uniquely identify a user, member, or customer, or otherwise characterize behavior of the user, member, or customer.

The terms “segment”, “sub-segment”, “group”, and their respective pluralized forms are used interchangeably throughout the specification, and are intended to identify a grouping of customers around a common characteristic or multiple common characteristics. For example, characteristics may be relatively simple as age or gender or may involve a complex statistical survey of the elements the segment or sub-segment of interest may have in common.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are methods and systems for customer performance scoring. In one embodiment, a system for providing a customer performance score can be provided. The system can include a processor or scoring module operable to determine at least one persistence factor based at least in part on a persistence attribute. Further, the processor or scoring module can be operable to determine at least one value factor based at least in part on a value attribute. In addition, the processor or scoring module can be operable to determine a customer performance score indicative of a customer's performance relative to other customers based at least in part on the at least one persistence factor and the at least one value factor. In another embodiment, a system for providing an online offer can be provided. The system can include a processor or scoring module operable to receive user identification information. Furthermore, the processor or scoring module can be operable to determine a customer performance score based at least in part on the user identification information. In addition, the processor or scoring module can be operable to determine an offer to extend to an online user based at least in part on the customer performance score.

Certain methods and systems for customer performance scoring can be particularly useful for distinguishing between or otherwise marketing to particular customers, such as customers for online transactions. In some instances, certain embodiments of the invention can increase personalization of an online experience for particular customers, which can result in increased customer loyalty and enhanced online business revenues. Tools provided by certain embodiments of the invention can permit certain users, such as administrative users, to analyze particular customer and market segments, and provide improved data for management and marketing decisions.

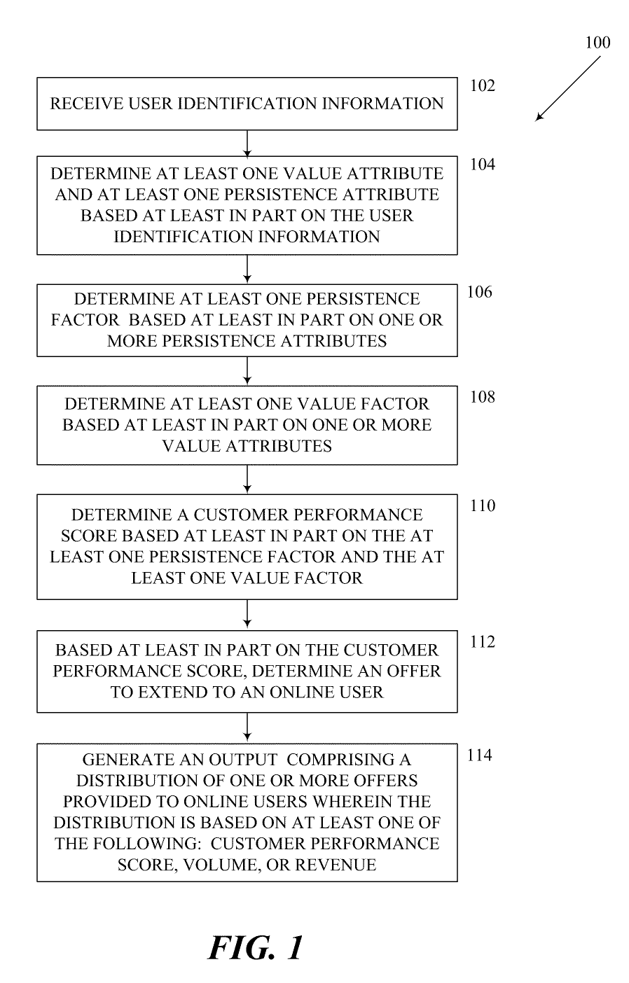

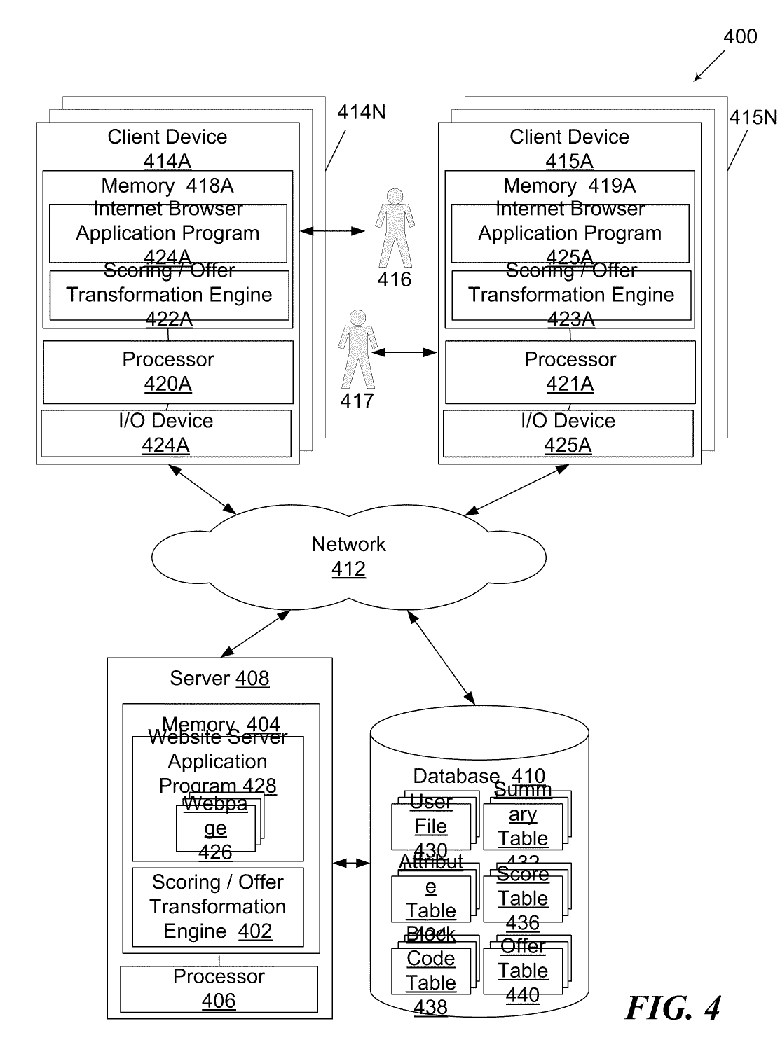

FIGS. 1-3 illustrate example methods according to various embodiments of the invention. Each of the methods can be implemented by a customer performance scoring system, for example, the system 400 shown in FIG. 4. In other embodiments, other similar methods can be implemented by the system 400 or similar system embodiments.

FIG. 1 illustrates a flowchart for one example method for customer performance scoring in accordance with an illustrative embodiment of the invention.

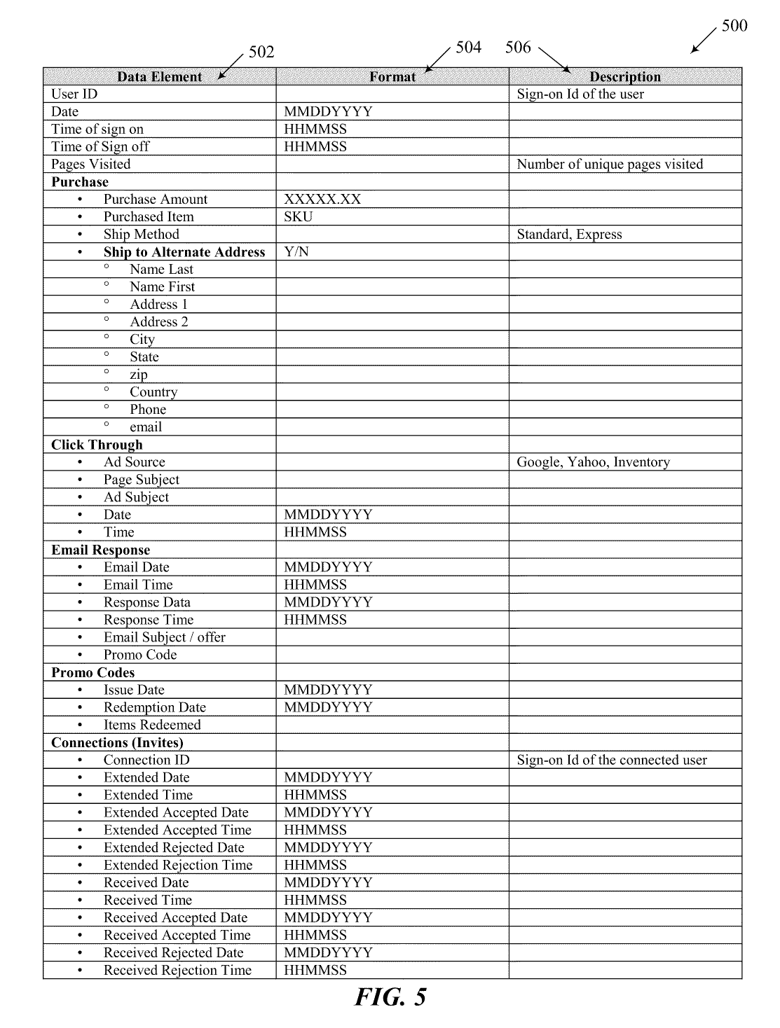

The method 100 begins at block 102, in which user identification information is received from at least one of the following: user input, or previously stored information from one or more data storage devices. An example system such as the customer performance scoring system 400 in FIG. 4 described below can be utilized to collect or otherwise receive user identification information is received or otherwise collected from one or more users or customers. For example, user identification information can be collected or otherwise received from one or more users or customers via one or more client devices 414A-414N of FIG. 4. A scoring/offer transformation engine 402 and/or associated processor 406 can communicate with the one or more client devices 414A-414N to receive the information. This information may include, but is not limited to, some or all of the following: user identification or login identification, name, address, e-mail address, home phone number, work phone number, mobile phone number, date of birth or age, specific preference information date, time of sign on, time of sign off, pages visited, purchase data, purchase amount, purchased item or service, shipping method, shipping address data, clickthrough data, ad source, page subject, ad subject, clickthrough or ad date, clickthrough or ad time, email response data, email date, email time, response data, response time, email subject/offer, promotional code, promotional code data, promotional code issue date, promotional code redemption date, promotional code item(s) redeemed, connections (invites) data, connection ID, extended date, extended time, extended accepted date, extended accepted time, extended rejected date, extended rejection time, received date, receive time, received accepted date, received accepted time, received rejected date, and received rejection time. An example customer data file or record is illustrated in FIG. 5 described below.

In one aspect of the embodiment, a website or a collection of one or more webpages or other electronic forms hosted by the scoring/offer transformation engine 402 and/or associated processor 406 can facilitate customer purchases of goods and/or services. In any instance, certain user identification information can be collected or otherwise received from the customers.

In one aspect of the embodiment, a loyalty or registration process can be implemented to require or otherwise encourage customers to register in order to purchase goods and/or receive services from the website or collection of one or more webpages or electronic forms or at a retail store point of sale system (POS). For example, a “Member Center” can be setup on a website as a homepage or gateway for customers to register and log-in each time he or she visits the website or collection of one or more webpages or electronic forms. As part of the loyalty or registration process, a customer can provide certain information to uniquely identify himself or herself, and this information can be stored and maintained by the Member Center. This information may include some or all of the information described above. In any instance, the information can be stored in an associated data storage device, such as a database 410 of FIG. 4, as a unique data file or record for each individual customer, and stored for subsequent retrieval and/or processing.

In one aspect of the embodiment, a retail store point of sale system (POS) may capture identification information such as phone number; drivers license number or name and address information that may uniquely identify the user or individual. For example, a phone number may be requested and entered as a component of the POS transaction to uniquely identify the user or individual, and this information can be stored and maintained by the Member Center. This information may include some or all of the information described above. In any instance, the information can be stored in an associated data storage device, such as database 410 of FIG. 4, as a unique data file or record for each individual user or customer, and stored for subsequent retrieval and/or processing.

In one aspect of the embodiment, user identification information can be stored in one or more data files or records stored in a data storage device such as database 410 in FIG. 4. Previously stored or collected user identification information can be extracted from the data files or records, and may be combined with other previously stored or collected user identification information in other data files or records from other data storage devices or databases. To facilitate data analysis and storage, the user identification information can be standardized in a common record format, edited for errors in format and content, and loaded into a processor, database, or memory for subsequent retrieval and/or processing.

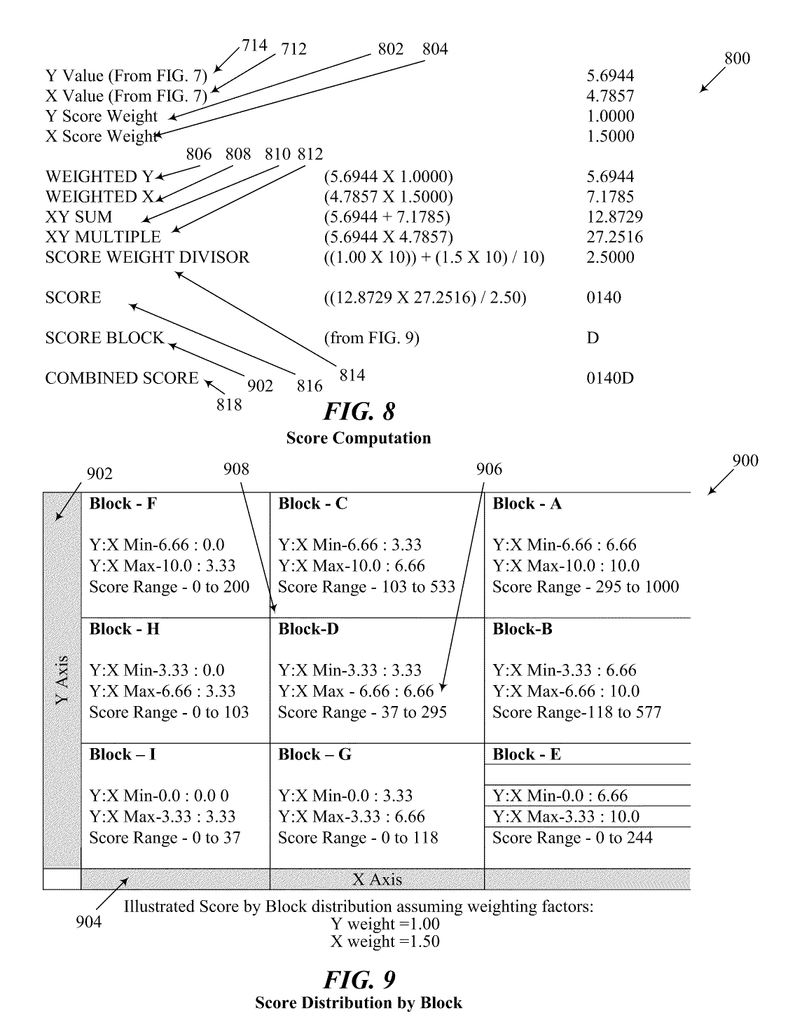

Returning to FIG. 1, block 102 is followed by block 104, in which a value attribute and a persistence attribute are determined based at least in part on the user identification information. In the embodiment shown in FIG. 1, one or more value attributes or X values can be determined by the scoring/offer transformation engine 402 and/or associated processor 406 of FIG. 4 based at least in part on user identification information. In addition, one or more persistence attributes or Y values can be determined by the scoring/offer transformation engine 402 and/or associated processor 406 based at least in part on the user identification information. Any number of rules, criteria, filters, or logic can be used to determine value attributes and persistence attributes from a particular set of user information. Example value attributes and persistence attributes are shown in FIG. 7 described below.

For example, value attributes can include, but are not limited to, some or all of the following:

Purchase Amount—Dollar amount of purchases (net of returns and allowances) made by a user or member over the observed time period.

Number of Purchases—Number of purchase transactions (measured as completed shopping cart check outs) made by a user or member over the observed time period.

Number of Items Purchased—Number of items purchased (net of returns and allowances) by a user or member over the observed time period.

Click Through (Sponsored)—Number of sponsored ads that a user or member selected or clicked through over the observed time period.

Click Through Dollars (Sponsored)—Dollars generated through sponsored ads that a user or member selected or clicked through over the observed time period.

Click Through (Owned)—Number of owned or hosted ads that a user or member selected or clicked through over the observed time period.

Click Through Dollars (Owned)—Dollars generated through owned or hosted ads that a user or member selected or clicked through over the observed time period.

Response to Solicitations—Percentage of offline (where the member is not logged into member center) responses from a user or member over the observed time period.

By way of further example, persistence attributes can include, but are not limited to, some or all of the following:

Recentness—Number of elapsed days since last log on.

Frequency—Number of times a member logs on over the observed time period.

Page Views—Number of pages a member has viewed over the observed time period.

Time on Site—Number of minutes/seconds that a user or member has been logged in over the observed time period.

Referrals/Invites Extended—Number of referrals or invitations extended by a user or member over the observed time period.

Referrals/Invites Accepted—Number of referrals or invitations extended by a user or member that have been accepted by the invitee over the observed time period.

Referral/Invite Acceptance Percentage—The percentage of referral or invitations accepted over the observed time period.

Referrals/Invites Received—Number of referrals or invitations received by a user or member over the observed time period.

Postings—Number of postings made by a user or member over the observed time period.

Completeness of Profile—Percentage of optional (non-required) fields in a user or member's profile that contain data. Fields may be weighted based on importance.

Block 104 is followed by block 106, in which at least one persistence factor is determined based at least in part on one or more persistence attributes. For example, in the embodiment shown in FIG. 1, at least one persistence factor can be determined by the scoring/offer transformation engine 402 and/or associated processor 406 of FIG. 4.

In one aspect of the embodiment, determining at least one persistence factor can include weighting a persistence attribute.

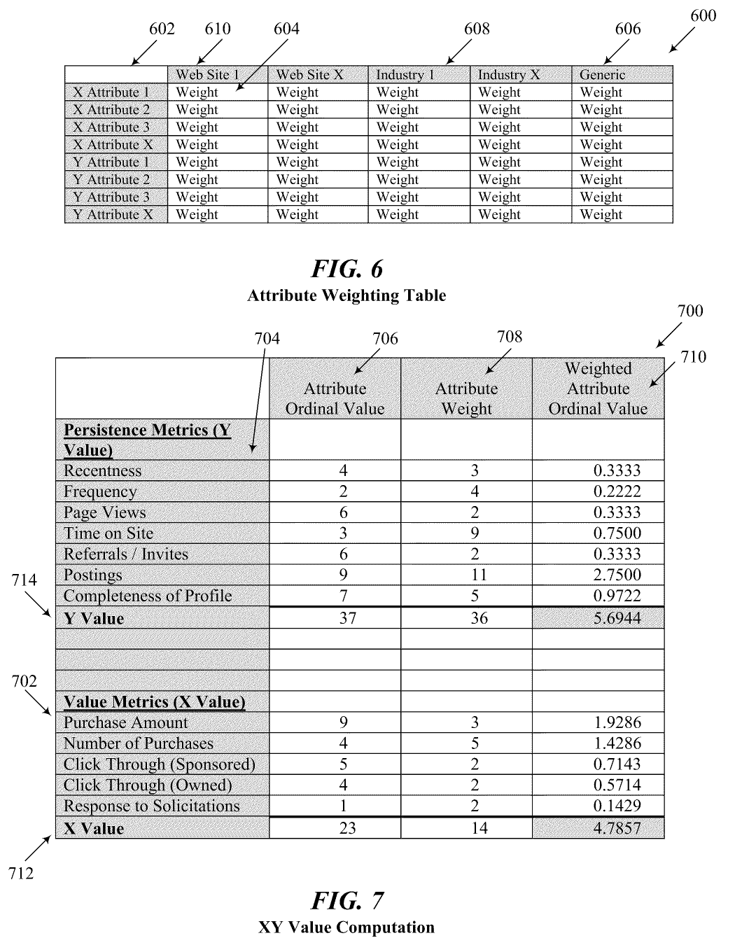

Block 106 is followed by block 108, in which at least one value factor is determined based at least in part on one or more value attributes. For example, in the embodiment shown in FIG. 1, at least one value factor can be determined by the scoring/offer transformation engine 402 and/or associated processor 406 of FIG. 4. Example weightings of several value attributes and persistence attributes are shown in FIGS. 6 and 7 described below.

In one aspect of the embodiment, determining at least one value factor can include weighting a value attribute.

Block 108 is followed by block 110, in which a customer performance score indicative of a customer's performance relative to other customers is determined based at least in part on the at least one persistence factor and the at least one value factor. For example, in the embodiment shown in FIG. 1, a customer performance score or other score can be determined by the scoring/offer transformation engine 402 and/or associated processor 406 of FIG. 4 based at least in part on the at least one persistence factor and the at least one value factor. Generally, the customer performance score or other score can depict the relative value of an individual customer compared to some or all other customers. An example customer performance score calculation is shown in FIG. 8 described below.

In one aspect of the embodiment, determining a customer performance score can include combining at least one persistence factor with at least one value factor.

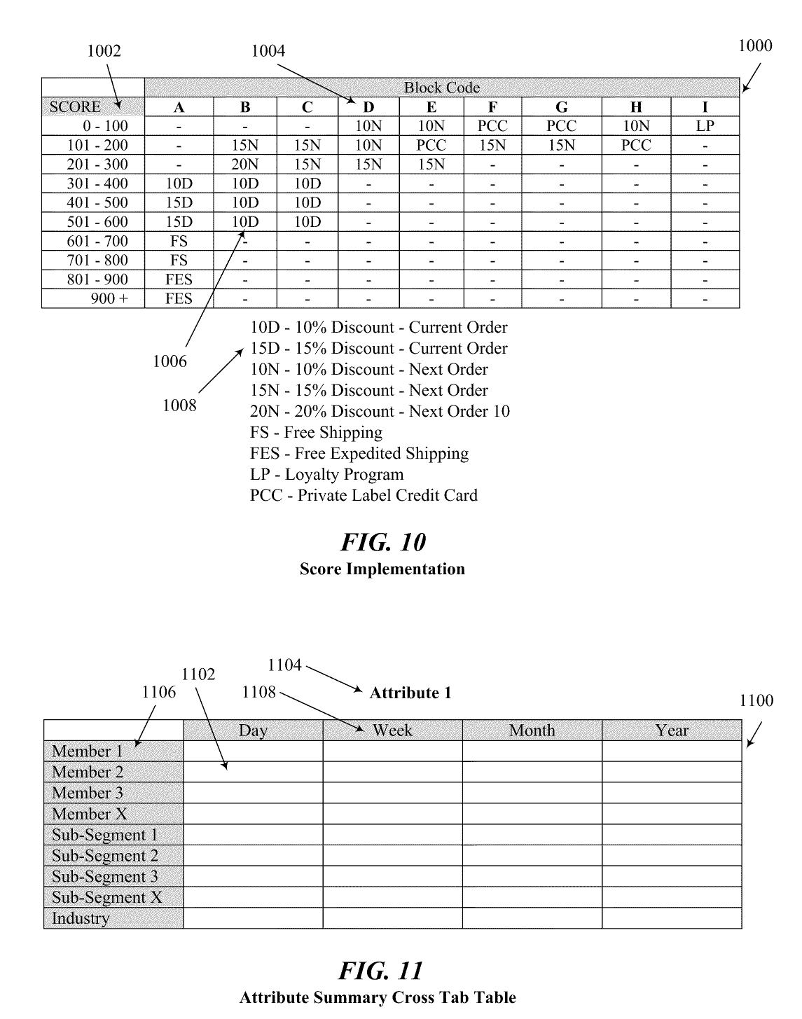

Block 110 is followed by block 112, in which an offer is provided to the online user based at least in part on the customer performance score. For example, in the embodiment shown in FIG. 1, the scoring/offer transformation engine 402 and/or associated processor 406 of FIG. 4 can provide an offer to the online customer. In certain aspects, providing an offer can include comparing the customer performance score against a plurality of predetermined scores and corresponding offers; and upon matching at least one of the plurality of predetermined scores, selecting at least one of the plurality of corresponding offers. For instance, as shown in FIG. 10 described below, a customer's customer performance score or other score can be used in a score table to reference a predetermined offer. Upon lookup of a corresponding offer based at least in part on the customer's customer performance score or other score, the offer can be transmitted or otherwise provided to a user such as an online user.

In one aspect of this embodiment, a user or customer such as 416 in FIG. 4 can transmit an indication of acceptance or decline of the offer via an associated client device such as 414A. In certain instances, the scoring/offer transformation engine 402 and/or associated processor 406 of FIG. 4 can store the indication as user identification information in a data storage device such as database 410. Such information can be subsequently used for determining subsequent offers to be transmitted to the same user or other users. For example, the indication of an acceptance or decline of a particular offer or offers may be used as an attribute that is included in subsequent model calculations.

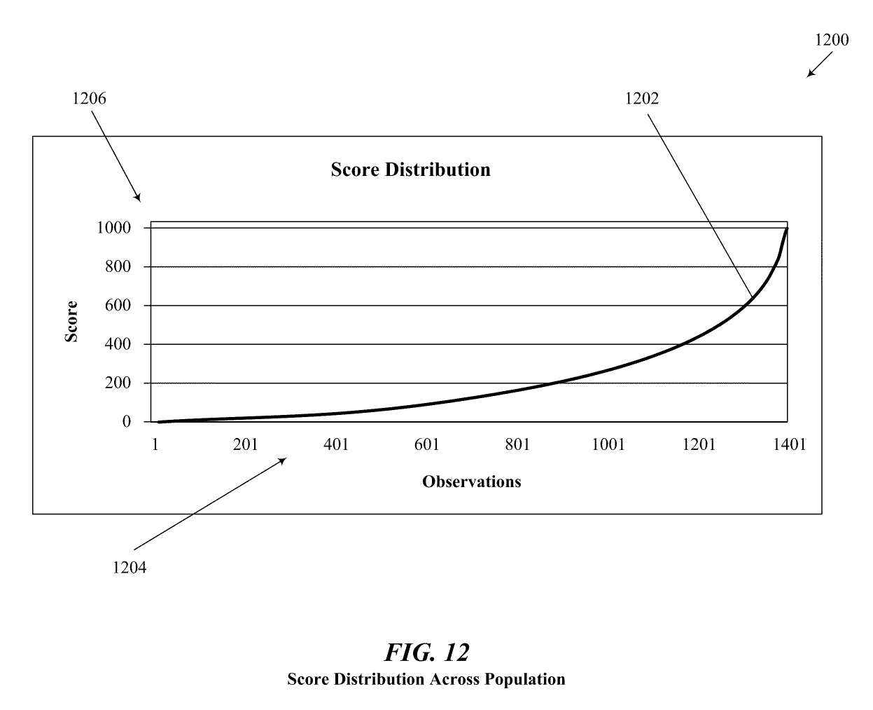

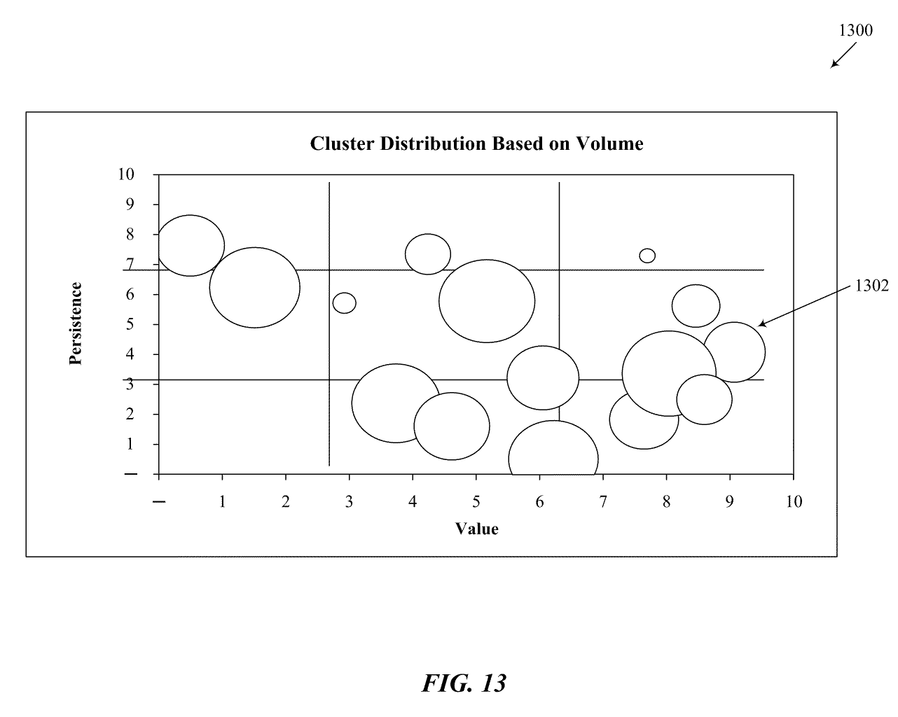

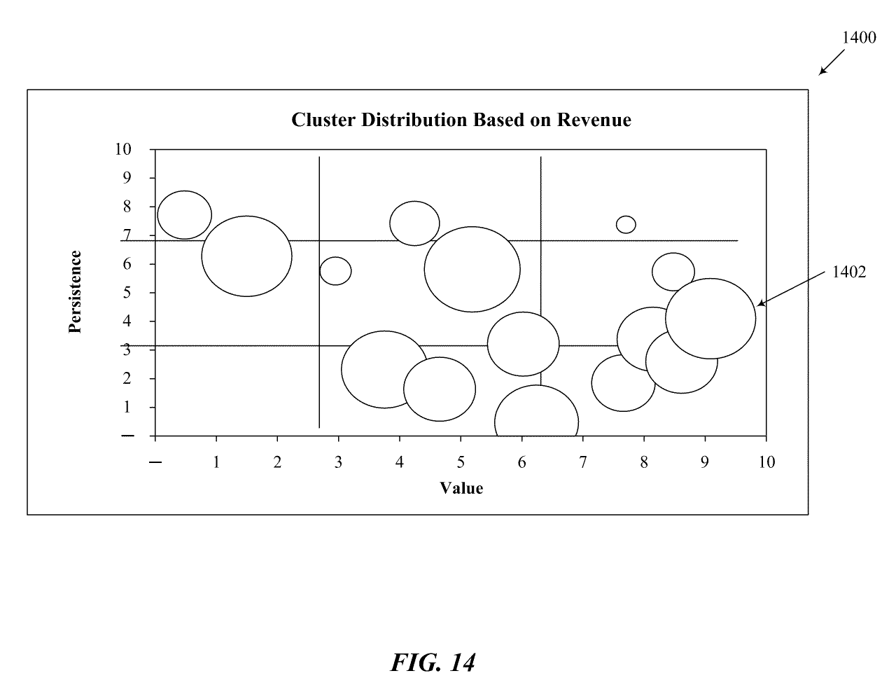

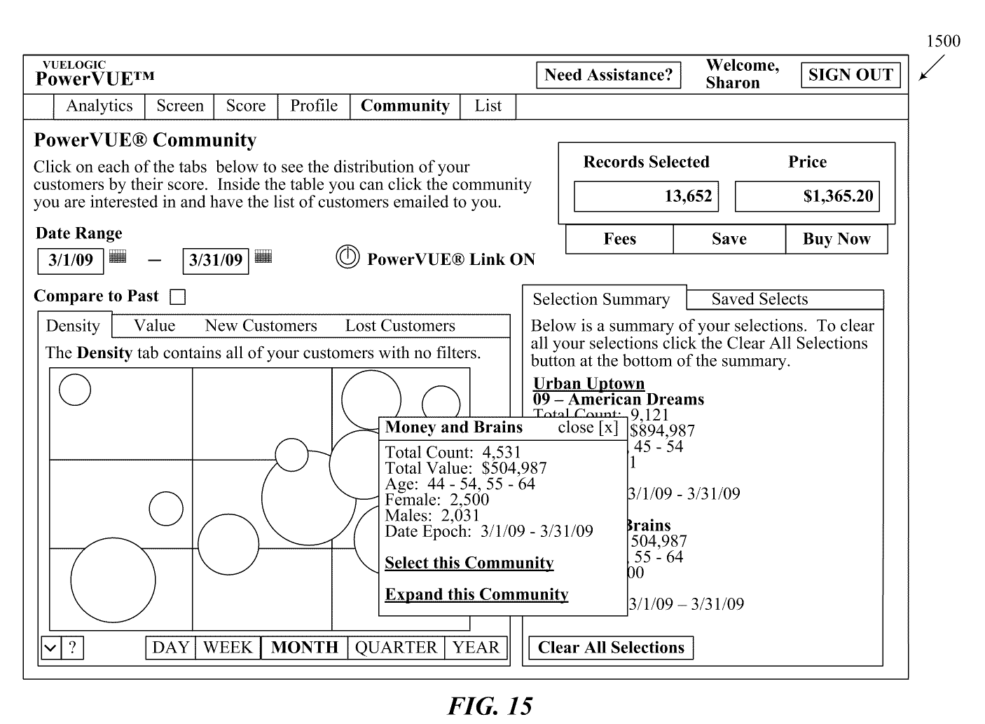

Block 112 is followed by optional block 114, in which an output is generated comprising a distribution of one or more offers provided to online users wherein the distribution is based on at least one of the following: customer performance score, volume, or revenue. For example, in the embodiment shown in FIG. 1, the scoring/offer transformation engine 402 and/or associated processor 406 of FIG. 4 can generate an output with a distribution of offers. In certain aspects, generating an output can include outputting a suitable distribution via a graphical interface to a certain user, such as an administrative user shown as 417 in FIG. 4. For instance, as shown in FIG. 12 described below, a graphical interface can display a graph with a score distribution of the number of observations versus customer performance score to an administrative user. Other example outputs according to certain embodiments are illustrated in FIGS. 13 to 14 described below, in which graphs representing certain sub-segments or clusters of customers can be output to an administrative user. Yet other example outputs according to certain embodiments are illustrated in FIG. 15 described below, in which an interactive user interface can present any number of options to an administrative user for viewing and purchasing selected distributions.

The method 100 may end following block 114.

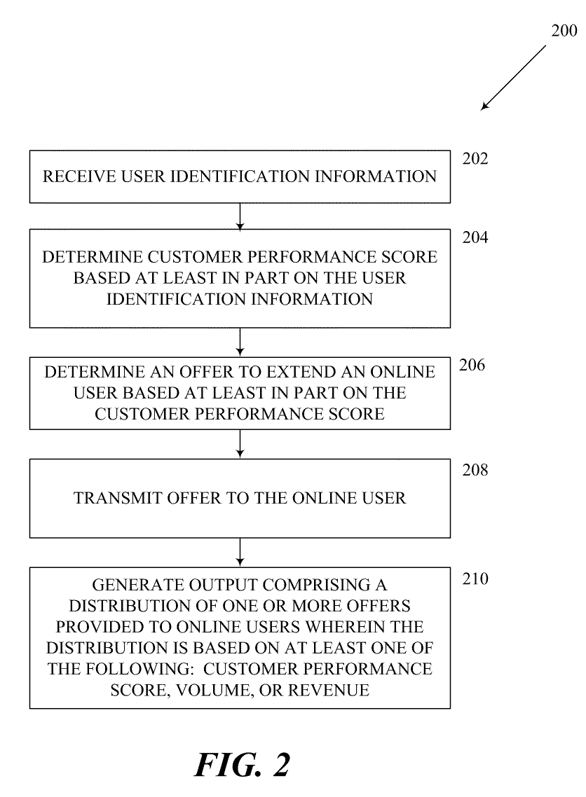

FIG. 2 illustrates a flowchart with an example method for providing an online offer in accordance with an illustrative embodiment of the invention.

The method 200 may begin at block 202, in which user identification information is received. For example, in the embodiment shown in FIG. 2, user identification information can be received from a user operating a client device such as 414A-414N in FIG. 4. An example customer data file or record containing user identification information is shown in FIG. 5 described below.

In one aspect of the invention, receiving user identification information can include receiving previously stored user information from one or more data storage devices. For example, user identification information can be received from a database such as 410 in FIG. 4.

Block 202 is followed by block 204, in which a customer performance score is determined based at least in part on the user identification information. For example, in the embodiment shown in FIG. 2, a customer performance score can be determined by a scoring/offer transformation engine 402 and/or associated processor 406 as shown in FIG. 4. FIG. 8 provides an example score value computation according to an embodiment of the invention.

In one aspect of the invention, determining a customer performance score can include determining at least one persistence attribute based at least in part on the user identification information; determining at least one value attribute based at least in part on the user identification information; and combining the at least one persistence attribute with the at least one value attribute. For example, the scoring/offer transformation engine 402 and/or associated processor 406 as shown in FIG. 4 can determine the customer performance score as described above.

Block 204 is followed by block 206, in which an offer to extend to an online user is determined based at least in part on the customer performance score. For example, in the embodiment shown in FIG. 2, a suitable offer can be determined by the scoring/offer transformation engine 402 and/or associated processor 406 as shown in FIG. 4.

In one aspect of the invention, determining an offer to extend to an online user can include comparing the customer performance score against a plurality of predetermined scores and corresponding offers; and upon matching at least one of the plurality of predetermined scores, selecting at least one of the plurality of corresponding offers. For example, the scoring/offer transformation engine 402 and/or associated processor 406 as shown in FIG. 4 can determine the offer as described above. FIG. 10 described below provides an example offer table according to an embodiment of the invention.

Block 206 is followed by block 208, in which the offer is transmitted to the online user. For example, in the embodiment shown in FIG. 2, the offer can be transmitted to the online user by the scoring/offer transformation engine 402 and/or associated processor 406 as shown in FIG. 4.

In one aspect of this embodiment, a user or customer such as 416 in FIG. 4 can transmit an indication of acceptance or decline of the offer via an associated client device such as 414A. In certain instances, the scoring/offer transformation engine 402 and/or associated processor 406 of FIG. 4 can store the indication as user identification information in a data storage device such as database 410. Such information can be subsequently used for determining subsequent offers to be transmitted to the same user or other users.

Block 208 is followed by optional block 210, in which an output comprising a distribution of one or more offers provided to online users is generated wherein the distribution is based on at least one of the following: customer performance score, volume, or revenue. In certain aspects, generating an output can include outputting a suitable distribution via a graphical interface to a certain user, such as an administrative user shown as 417 in FIG. 4 For example, in the embodiment shown in FIG. 2, an output can be provided by the scoring/offer transformation engine 402 and/or associated processor 406 as shown in FIG. 4. FIGS. 13, 14, and 15, described below, provide example outputs in accordance with certain embodiments of the invention.

The method 200 may end following block 210.

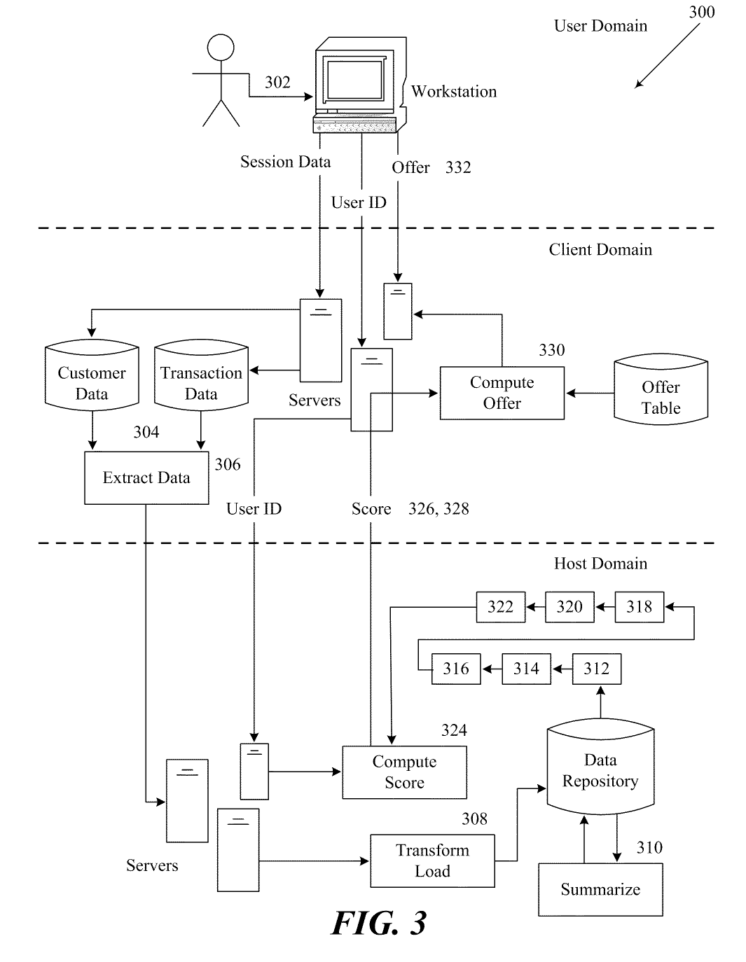

FIG. 3 illustrates a data flow for an example method for customer performance scoring and providing an online offer in accordance with an illustrative embodiment of the invention.

The method 300 may begin at block 302, in which user identification information is received from a customer or user. For example, in the embodiment shown in FIG. 3, user identification information can be received from a user operating a client device such as 414A-414N in FIG. 4.

Block 302 is followed by block 304, in which some or all of the user identification information is stored. For example, in the embodiment shown in FIG. 3, some or all of the user identification information can be stored by a scoring/offer transformation engine 402 and/or associated processor 406 of FIG. 4 in one or more data storage devices such as database 410.

Block 304 is followed by block 306, in which user identification information is extracted from at least one data storage device. For example, in the embodiment shown in FIG. 3, some or all of the previously stored user identification information can be extracted from the database 410 by the scoring/offer transformation engine 402 and/or associated processor 406.

Block 306 is followed by block 308, in which the extracted user identification information is transformed into a suitable processing data structure or table. For example, in the embodiment shown in FIG. 3, some or all of the extracted user identification information can be formatted by the scoring/offer transformation engine 402 and/or associated processor 406 in a table or other similar data structure such as the example table format illustrated in FIG. 5 described below.

Block 308 is followed by block 310, in which at least one data summation is generated based at least in part on at least some of the extracted user identification information. In the embodiment shown in FIG. 3, selected user identification information can be summarized by the scoring/offer transformation engine 402 and/or associated processor 406 over one or more predefined time periods. For instance, as shown in a summary cross tab table in FIG. 11 described below, some or all extracted user identification information can be summarized by customer and at least one observed time period including, but not limited to, the following time periods: daily, weekly (Sunday to Saturday), bi-weekly (two contiguous weeks), monthly (as defined by the Julian Calendar), bi-monthly (two contiguous months), quarterly (three contiguous months—January to March, April to June, July to September and October to December), semi-annual (six contiguous months—January to June and July to December), annual (as defined by the Julian Calendar), and bi-Annual (two contiguous annual periods). In the embodiment shown in FIG. 3, daily information can be stored and maintained for a certain minimum time, such as 395 days. At the end of each week, subsequently at the end of each month, and at the end of the year, the data for a particular attribute/member can summarized into each of the relatively larger time periods. For instance, the weekly file can be maintained for a certain minimum time, such as 58 weeks, the monthly file can be maintained for a certain minimum time, such as 14 months, and the annual file can be maintained for a certain minimum time, such as 3 years.

Block 310 is followed by block 312, in which the at least one data summation and at least some of the extracted user identification information are input to a model, such as a scoring/order transformation engine. In the embodiment shown in FIG. 3, the data summation and extracted user identification information can be input to the scoring/offer transformation engine 402 and/or associated processor 406 for further processing.

Block 312 is followed by block 314, in which one or more interim/observed values are determined. In the embodiment shown in FIG. 3, an “attribute observed value” can be computed by the scoring/offer transformation engine 402 and/or associated processor 406 of FIG. 4 by aggregating all data captured for a certain observed attribute over a particular observed time period.

In one aspect of this embodiment, one measure of the aggregation can be an element of time such as in seconds. In other aspects, another measure of the aggregation can be monetary such as in the currency the transaction is transacted in. In another aspect, yet another measure of the aggregation may be neither time nor monetary, and may be in other suitable units of measure.

Block 314 is followed by block 316, in which one or more attribute ordinal values are determined. In the embodiment shown in FIG. 3, an “attribute ordinal value” can be the relative position of the attribute observed value within a predefined attribute domain range. The attribute ordinal value can be determined by the scoring/offer transformation engine 402 and/or associated processor 406 of FIG. 4 by subtracting the minimum value in the attribute domain range from the attribute observed value and dividing the difference by the difference in the maximum and minimum attribute domain range values. The result can be multiplied by about 10 to obtain an ordinal value between about 0 and about 10. An example X and Y value computation in FIG. 7 described below shows example attribute ordinal values.

Block 316 is followed by block 318, in which one or more attribute weighted ordinal values are determined. In the embodiment shown in FIG. 3, each attribute ordinal value can be weighted by the scoring/offer transformation engine 402 and/or associated processor 406 of FIG. 4 based on its relative importance to the other attributes being measured in the X and/or Y computation. An example attribute weighting table such as FIG. 6 described below can maintain or otherwise provide certain predefined weights for each attribute. Thus, the scoring/offer transformation engine 402 and/or associated processor 406 can multiply the attribute ordinal value by the attribute weight from the attribute weighting table, and divide by the sum of the attribute weights to obtain a result known as the attribute weighted ordinal value. An example X and Y value computation illustrating example attribute weighted ordinal values is shown in FIG. 7 described below.

In other aspects of the embodiment, weighting can be generic (for instance, across all sites in a particular captured universe), industry-specified or specific (for instance, all sites in an industry four digit SIC level), or site specific (for instance, for a single specified site) depending on a need.

Block 318 is followed by block 320, in which one or more X-Y coordinates are determined. In the embodiment shown in FIG. 3, a Y value can be determined by the scoring/offer transformation engine 402 and/or associated processor 406 of FIG. 4 by summing the attribute weighted ordinal value for some or all of the persistence attributes. Furthermore, a X value can be determined by the scoring/offer transformation engine 402 and/or associated processor 406 by summing the attribute weighted ordinal value for some or all of the value attributes. An example X and Y value computation is shown in FIG. 7 described below.

Block 320 is followed by block 322, in which one or more attribute domain ranges are determined. In the embodiment shown in FIG. 3, an initial measure can be established the scoring/offer transformation engine 402 and/or associated processor 406 of FIG. 4 by determining the median and standard deviation of the value being measured. For example, three (3) standard deviations from either side of the median or mean can constitute the “attribute domain range” or boundaries of measurement provided that the attribute domain range may not exceed the greatest observed value nor be less than the least observed value. Any observations outside the attribute domain range can be assigned the maximum or minimum value of the attribute domain range closest to the observed value.

Block 322 is followed by block 324, in which a customer performance score is determined. In the embodiment shown in FIG. 3, the scoring/offer transformation engine 402 and/or associated processor 406 of FIG. 4 can multiply the Y value by the Y Score Weight (WEIGHTED Y). Next, the X value can be multiplied by the X Score Weight (WEIGHTED X). The WEIGHTED Y can then be added to the WEIGHTED X (XY SUM). Then, the Y value can be multiplied by the X value (XY MULTIPLE). The Y Score Weight and X Score Weight (SCORE WEIGHT DIVISOR) can be added together. Then, XY SUM can be multiplied by XY MULTIPLE, and the result divided by SCORE WEIGHT DIVISOR and rounded to the nearest whole number. Thus, an example customer performance score can be determined by the example equation:

$$\frac{[ [ ( Y * Y Score Weight ) + ( X * X Score Weight ) ] * ( Y * X ) ]}{[ Y Score Weight + X Score Weight ]}$$

An example customer performance score or score computation is also described in FIG. 8 below.

Block 324 is followed by block 326, in which block code is generated. In the embodiment shown in FIG. 3, the scoring/offer transformation engine 402 and/or associated processor 406 of FIG. 4 can utilize the customer performance score in conjunction with certain XY coordinates to create a combined score. For example, as shown in FIGS. 9 and 10 described below, a block code or letter representing the respective block in which the XY coordinate resides can be appended to the customer performance score or score resulting in, for instance, a five (5) digit alphanumeric code or combined score.

Block 326 is followed by block 328, in which a score and/or associated data is output. In the embodiment shown in FIG. 3, the scoring/offer transformation engine 402 and/or associated processor 406 of FIG. 4 can output a score and/or associated data, such as a block code or customer performance score, for various uses, such as providing an online offer to a customer. For example, a score and/or combined score can be output as shown in FIG. 8 described below.

Block 328 is followed by block 330 in which the score is used to determine an offer for the customer. For example, in the embodiment of FIG. 3, the scoring/offer transformation engine 402 and/or associated processor 406 can use the score to determine one or more offers. An offer table, such as illustrated in FIG. 10 described below, can provide any number of differing or similar offers to a particular customer based on the customer's value contribution. In this manner, some or all of the offers can either maintain or enhance customer satisfaction for relatively high value customers or otherwise induce additional transactions by marginal or relatively low value customers.

Block 330 is followed by block 332 in which at least one offer is transmitted to the customer. For example, in the embodiment of FIG. 3, the scoring/offer transformation engine 402 and/or associated processor 406 can transmit at least one offer, determined for a particular customer, to the customer of interest. In the embodiment of FIG. 3, a customer can receive the offer via a client device, such as 414A-414N in FIG. 4.

In one aspect of this embodiment, a user or customer such as 416 in FIG. 4 can transmit an indication of acceptance or decline of the offer via an associated client device such as 414A. In certain instances, the scoring/offer transformation engine 402 and/or associated processor 406 of FIG. 4 can store the indication as user identification information in a data storage device such as database 410. Such information can be subsequently used for determining subsequent offers to be transmitted to the same user or other users.

The method 300 may end following block 332.

The operations described in the methods 100, 200, and 300 of respective FIGS. 1-3 do not necessarily have to be performed in the order set forth in FIGS. 1-3, but instead may be performed in any suitable order. Additionally, in certain embodiments of the invention, more or less than all of the elements or operations set forth in FIGS. 1-3 may be performed.

FIG. 4 is a perspective view of one example of a system in accordance with an embodiment of the invention. FIG. 4 illustrates an example system for customer performance scoring. For example, a system 400 shown in FIG. 4 can implement an associated process, such as 100 in FIG. 1, utilizing a scoring/offer transformation engine, such as 402. In other embodiments, the system 400 can implement other processes described herein, for instance, processes shown and described with respect to FIGS. 2 and 3. The scoring/offer transformation engine 402 shown in FIG. 4 can be a set of computer-executable instructions stored in a memory, such as 404, and operable to execute via a processor, such as 406. The scoring/offer transformation engine 402, memory 404, and processor 406 can be located at or otherwise accessible via a processor-based device such as a computer server or server device, for instance 408. In one embodiment, a database 410 or other data storage device can be in communication with the server device 408, and can be electronically accessed by the server device 408 either through a network 412 or by direct communication. Any number of other processor-based devices or server devices can also be in communication with the network 412. Through the network 412, or by direct communication, one or more client devices such as 414A-414N, 415A-415N can communicate with the scoring/offer transformation engine 402 and server 408. In the embodiment shown, a user or customer, such as 416, can utilize a particular client device 414A to communicate with or otherwise interact with the scoring/offer transformation engine 402 and server 408. Also shown in this embodiment, a user or administrative user, such as 417, can utilize a particular client device 415A to communicate with or otherwise interact with the scoring/offer transformation engine 402 and server 408. Each client device 414A-414N, 415A-415N can include a respective memory 418A-418N, 419A-419N and processor 420A-420N, 421A-421N and in certain instances, may include computer-executable instructions 422A-422N, 423A-423N similar to those of the scoring/offer transformation engine 402. In most instances, each of the client devices 414A-414N, 415A-415N can include an associated output device, such as a display 424A-424N, 425A-425N, for outputting one or more offers and/or presentations or graphical interfaces generated by the scoring/offer transformation engine 402.

Each client device 414A-414N, 415A-415N can be a computer or processor-based device capable of communicating with the communications network 412 via a signal, such as a wireless frequency signal or a direct wired communication signal. Client devices 414A-414N, 415A-415N may also comprise a number of other external or internal devices such as a mouse, a CD-ROM, DVD, a keyboard, a display, printer, printing device, output display, display screen, a tactile device, a speaker, mobile phone, TV set top box or other input or output devices. For example, a client device such as 414A can be in communication with an output device via a communication or input/output interface. Examples of client devices 414A-414N, 415A-415N are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 414A, may be any type of processor-based platform that is connected to a network, such as 412, and that interacts with one or more application programs. Client devices 414A-414N, 415A-415N may operate on any operating system capable of supporting a browser or browser-enabled application such as 424A-424N, 425A-425N including, but not limited to, Microsoft Windows®, Apple OSX™, and Linux. The client devices 414A-414N, 415A-415N shown include, for example, personal computers executing a browser application program such as Microsoft Corporation's Internet Explorer™, Netscape Communication Corporation's Netscape Navigator™, and Apple's Safari™, and Mozilla Firefox™.

In one embodiment, suitable client devices can be standard desktop personal computers with Intel x86 processor architecture, operating a Microsoft® Windows® operating system, and programmed using a Java language.

Server 408, each depicted as a single computer system, may be implemented as a network of computer processors. Examples of suitable servers are server devices, mainframe computers, networked computers, a processor-based device, and similar types of systems and devices.

Suitable processors for client devices 414A-414N, 415A-415N, and a server 408 may comprise a microprocessor, an ASIC, and state machines. Example processors can be those provided by Intel Corporation and Motorola Corporation. Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processors 406, 420A-420N, 421A-421N, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

The network 412 shown in FIG. 4 can be, for example, the Internet. In another embodiment, the network 412 can be a wireless communications network capable of transmitting both voice and data signals, including image data signals or multimedia signals. Other types of communications networks, including local area networks (LAN), wide area networks (WAN), a public switched telephone network, or combinations thereof can be used in accordance with various embodiments of the invention.

Any number of users, such as 416, 417, can interact with a respective client device, such as 414A-414N, 415A-415N, via any number of associated input and output devices such as an output display device, keyboard, tactile device, speaker, and a mouse. In this manner, a user 416, 417 can access one or more presentations, graphical interfaces, or webpages 426 located on or otherwise generated by a server, such as 408, using a website server application program, such as 428, via an Internet browser application program, such as 424A, 425A operating on a client device, such as 414A, 415A.

In one aspect of the embodiment shown in FIG. 4, any number of data storage devices such as one or more databases, for instance 410, can store any number of files or records containing user identification data 430, summary tables containing certain extracted user identification data and predefined attributes 432, attribute weighting tables containing selected attributes or factors and respective weights 434, scoring distribution tables 436, block code tables 438, and offer tables 440.

Using the foregoing system 400, a scoring/offer transformation engine 402 and/or associated processor 406 can transform a user's input into one or more suitable information formats and/or tables, and further transform certain user identification information into a customer performance score or other score. Such a score can be used to facilitate or otherwise provide one or more offers to an online user. In this manner, the technical problem of transforming disparate user information into useful data to distinguish one user or customer from some or all other users or customers can be solved by transforming such information into a single customer performance score or other score for use in targeting the user with particular offers of potential interest. Such offers can maintain or enhance customer satisfaction for certain relatively high value customers and can induce or encourage additional transactions with marginal or relatively low value customers. In certain instances, comparing scores derived from different observed time periods can also be used to determine performance trends which can indicate the increasing or decreasing value of a particular customer or sub-segment of interest. The velocity or magnitude of change over an observed time period can defines the relative stability and/or predictability of the customer or sub-segment of interest.

One may recognize the applicability of embodiments of the invention to other environments, contexts, and applications. One will appreciate that components of the system 100 shown in and described with respect to FIG. 4 are provided by way of example only. Numerous other operating environments, system architectures, and device configurations are possible. Accordingly, embodiments of the invention should not be construed as being limited to any particular operating environment, system architecture, or device configuration.

FIG. 5 is an example customer data record or file according to an illustrative embodiment of the invention. The customer data record 500 can include any number of data elements 502 with respective defined formats 504, and a description 506 of the data elements and/or format. The data elements 502 can include, but are not be limited to, various user identification information such as user identification or login identification, name, address, e-mail address, home phone number, work phone number, mobile phone number, date of birth or age, specific preference information date, time of sign on, time of sign off, pages visited, purchase data, purchase amount, purchased item or service, shipping method, shipping address data, clickthrough data, ad source, page subject, ad subject, clickthrough or ad date, clickthrough or ad time, email response data, email date, email time, response data, response time, email subject/offer, promotional code, promotional code data, promotional code issue date, promotional code redemption date, promotional code item(s) redeemed, connections (invites) data, connection ID, extended date, extended time, extended accepted date, extended accepted time, extended rejected date, extended rejection time, received date, receive time, received accepted date, received accepted time, received rejected date, and received rejection time. The formats 504 can include, but are not limited to, date format, time format, currency format, SKU number format, yes/no format, or other alphanumeric formats. The description 506 of the data elements and/or format can include, but is not limited to, ranges for data elements 504, or other data describing data elements and/or format. Other suitable embodiments of a customer data record or file can include these or other components.

FIG. 6 is an example attribute weighting table according to an illustrative embodiment of the invention. The attribute weighting table 600 can include any number of attributes 602, and as needed, any number of certain weights 604 can be assigned according to particular categories an attribute may be associated with. For instance, the weighting may be generic 606 (for instance, across all sites in a particular captured universe), industry-specified or specific 608 (for instance, all sites in an industry four digit SIC level), or site specific 610 (for instance, for a single specified site). Other suitable embodiments of an attribute weighting table, weights, and categories can include these or other components.

FIG. 7 illustrates an example X and Y value computation according to an illustrative embodiment of the invention. The example computation 700 includes one or more value attributes, or X values 702, and one or more persistence attributes, or Y values 704, with corresponding attribute ordinal values 706, attribute weights 708, and weighted attribute ordinal values 710 being determined or otherwise assigned to the respective values 702, 704. As shown in FIG. 7, a X value 712 and a Y value 714 for a particular set of value attributes, such as 702, and persistence attributes, such as 704, can be determined. Other suitable embodiments of a value computation can include these or other components.

FIG. 8 illustrates an example score computation according to an illustrative embodiment of the invention. The example computation 800 includes a previously determined Y value, such as 714 from FIG. 7, a previously determined X value, such as 712, a Y score weight 802, and a X score weight 804. A weighted Y value 806 is determined using Y value 714 and Y score weight 802, and a weighted X value 808 is determined using the X value 712 and X score weight 804. An XY sum 810 and XY multiple 812 are determined using the weighted Y value 806 and weighted X value 808. A score weight divisor 814 can be determined using the Y score weight 802 and X score weight 804. Using some or all of the above values, a score 816 can be determined. Other suitable embodiments of a score computation can include these or other components.

In one aspect of the embodiment, a previously determined score block, such as D 908 from FIG. 9, can be used with the score 816 to determine a combined score, such as 0140D 818.

FIG. 9 illustrates an example score distribution by block according to an illustrative embodiment of the invention. For example, as shown in FIG. 9, a customer performance score or other score can depict an aggregated sub-segment of a particular customer set. One relative value can be depicted as a point (XY coordinate) within, for instance, a nine (9) block grid 900 on a two-dimensional XY graph as an absolute score or a combination of the two. The Y values 902 can represent the persistence of the customer or sub-segment of customers and the X values 904 can represent the monetary value of the customer or sub-segment of customers. For each particular block, the customer performance score 906 or other score can depict the relative value of a customer along, for instance, a 1000 point scale. When combined, the customer performance score or other score can be followed by a XY coordinate block assignment, such as D 908, to compose a combined score as shown as 818 in FIG. 8. Other suitable embodiments of a score distribution can include these or other components.

As shown in FIG. 9, the grid 900 can be a square-shaped box with a maximum X ordinal value of, for instance, 10, a maximum Y ordinal value of, for instance, 10, a minimal X ordinal value of, for instance, 0, and a minimal Y ordinal value of, for instance, 0. The grid 900 is shown subdivided into 9 sub-boxes by drawing horizontal or vertical lines (dependent on the axis) at the approximate values of 3.333 and 6.667. The sub-boxes are labeled, for example, A to I and each of the sub-box boundaries are defined as depicted in FIG. 9. The example letter codes of A to I can be appended to each numeric score based on the X and Y coordinates for a particular observation. If the X:Y coordinate is within the boundaries of the sub-box, is the X:Y coordinate can be assigned the respective letter code of the sub-block.

FIG. 10 illustrates an example score implementation according to an illustrative embodiment of the invention. In the table 1000 shown in FIG. 10, also known as an offer table, various score ranges 1002 and block codes 1004 can be aligned to create a grid with respective offers 1006 in one or more grid zones. In this example, each offer 1006 may be a code, such as “10D”, that corresponds to other details 1008 regarding the offer, such as “10% Discount−Current Order.” Other suitable embodiments of a score implementation can include these or other components.

FIG. 11 illustrates an example summary cross tab table according to an illustrative embodiment of the invention. In the table 1100 shown in FIG. 11, also known as a summary table, certain user identification information 1102 can be summarized for a particular attribute, such as “Attribute 1” 1104. Such information 1102 can be collected or otherwise extracted from one or more data files or records, and organized by a predefined grouping 1106 such as user or member ID, sub-segment identification, industry, or other segment, sub-segment, or grouping. In addition, various data can be stored in the table 1100 for any number of predefined time periods 1108, such as by day, week, month, or year. Other suitable embodiments of a summary cross tab table can include these or other components.

FIGS. 12-15 illustrate various outputs, webpages, and other graphical interfaces for use by certain users, such as an administrative user shown as 417 in FIG. 4.

FIG. 12 illustrates an example score distribution according to an illustrative embodiment of the invention. In the graph 1200 shown in FIG. 12, a distribution 1202 of observations (X-axis 1204) is shown against scores (Y-axis 1206). Other suitable embodiments of a score distribution can include these or other components.

FIGS. 13 and 14 illustrate other example score distributions according to an illustrative embodiment of the invention. Typically, one or more webpages and associated presentations with such distributions can be output from a scoring/offer transformation engine, such as 402, and/or an associated processor, such as 406, of FIG. 4. For example, when one or more sub-segments is defined and used to analyze data, a third dimension can graphically depict the relative size of various sub-segments of interest, shown as different size bubbles 1302, 1402 on the respective XY graphs of FIGS. 13 and 14.

As shown in FIGS. 13 and 14, respective grids 1300, 1400 can depict relative placement of each performance measure, for instance, persistence and value. Each grid 1300, 1400 includes, for instance, nine (9) block equilateral grids in a three block by three block configuration to further depict the relative placement of each performance measure. Adjacent to or under the scoring model various XY coordinates can represent the same score. The placement of the XY coordinate within the nine block grid can further discriminate between the character and behavior of a particular customer or sub-segment, such as based on volume in FIG. 13 and based on revenue in FIG. 14. In this manner, specific customer management strategies can be devised and implemented for each block to further define how to manage customer interaction. Over time, comparing customer performance scores derived from one or more different observed time periods can provide data for another graphical user interface displaying a performance time trend. In this manner, increasing or decreasing relative value of a customer or sub-segment can be observed. For example, the velocity or magnitude of a change in customer performance score over a particular time period can define the relative stability and predictability of the particular customer or sub-segment of interest.

FIG. 15 illustrates an example user interface for implementing a system and method in accordance with an illustrative embodiment of the invention. As shown in FIG. 15, the interface 1500 can include any number of analytical tools and user options to analyze some or all customers using the system, such as the customer performance score system 400 in FIG. 4. For example, an administrative user such as 417 in FIG. 4 may want to analyze certain customers having a particular range of customer performance scores over a predefined range of dates. In another example, an administrative user may want to analyze different distributions of scores for a selected group of customers, such as based on gender, race, age, demographic, location, or any number of other common characteristics. In certain embodiments, particular groups and/or analyses of interest can be stored by the system 400 for subsequent retrieval. In this manner, an administrative user such as 417 may generate target lists and/or marketing plans using selected customers. Marketing campaigns can be executed relatively quicker and more efficiently using such information.

In one aspect of this embodiment, an administrative user may be charged a fee by a host entity based on the number of customers and/or corresponding records selected and/or analyzed.

It will be apparent to a person skilled in the art that the value of ranges given in the above embodiments are only for exemplary purposes and are not intended to limit or deviate the scope of the invention.

Embodiments of the invention are described above with reference to block diagrams and schematic illustrations of methods and systems according to embodiments of the invention. It will be understood that each block of the diagrams, and combinations of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. For example, certain computer program instructions may be loaded onto a marketing computer or processor to create a special purpose marketing computer or processor. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose embodiments of the invention, including the best mode, and also to enable any person skilled in the art to practice the invention, including making and using any devices or systems and performing any incorporated methods. The patentable scope of embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The claimed invention is:

1. A method for providing an online offer, comprising:
receiving user identification information;
based at least in part on the user identification information, determining a customer performance score;
based at least in part on the customer performance score, determining an offer to extend to an online user.

2. The method of claim 1, further comprising:
transmitting the offer to the online user.

3. The method of claim 1, wherein receiving user identification information comprises receiving previously stored user information from one or more data storage devices.

4. The method of claim 1, wherein determining a customer performance score comprises:
determining at least one persistence attribute based at least in part on the user identification information;
determining at least one value attribute based at least in part on the user identification information; and
combining the at least one persistence attribute with the at least one value attribute.

5. The method of claim 1, wherein determining an offer to extend to an online user comprises:
comparing the customer performance score against a plurality of predetermined scores and corresponding offers; and
upon matching at least one of the plurality of predetermined scores, selecting at least one of the plurality of corresponding offers.

6. The method of claim 1, further comprising:
generating an output comprising a distribution of one or more offers provided to online users wherein the distribution is based on at least one of the following: customer performance score, volume, or revenue.

7. A method for determining a customer performance score, comprising:
based at least in part on a persistence attribute, determining at least one persistence factor;
based at least in part on a value attribute, determining at least one value factor; and
based at least in part on the at least one persistence factor and the at least one value factor, determining a customer performance score indicative of a customer's performance relative to other customers.

8. The method of claim 7, further comprising:
receiving user information from at least one of the following: user input or from one or more data storage devices; and
based at least in part on the user information, determining a persistence attribute and a value attribute.

9. The method of claim 7, wherein determining at least one persistence factor comprises weighting the persistence attribute; and wherein determining at least one value factor comprises weighting the value attribute.

10. The method of claim 7, wherein determining a customer performance score comprises:
combining the persistence factor with the value factor.

11. The method of claim 7, further comprising:
based at least in part on the customer performance score, providing an offer to the online user.

12. The method of claim 11, wherein providing an offer to the online user comprises:
comparing the customer performance score against a plurality of predetermined scores and corresponding offers; and
upon matching at least one of the plurality of predetermined scores, selecting at least one of the plurality of corresponding offers.

13. The method of claim 11, further comprising:
generating an output comprising a distribution of one or more offers provided to online users wherein the distribution is based on at least one of the following: customer performance score, volume, or revenue.

14. A system for providing an online offer, comprising:
a processor operable to:
receive user identification information;
determine a customer performance score based at least in part on the user identification information; and
determine an offer to extend to an online user based at least in part on the customer performance score.

15. The system of claim 14, wherein the processor is further operable to:
transmit the offer to the online user.

16. A system for determining a customer performance score, comprising:
a processor operable to:
determine at least one persistence factor based at least in part on a persistence attribute;
determine at least one value factor based at least in part on a value attribute; and
determine a customer performance score indicative of a customer's performance relative to other customers based at least in part on the at least one persistence factor and the at least one value factor.

17. The system of claim 16, further comprising:
receiving user information from at least one of the following: user input or from one or more data storage devices; and
based at least in part on the user information, determining a persistence attribute and a value attribute.

18. The system of claim 16, further comprising:
providing an offer to the online user based at least in part on the customer performance score.

19. The system of claim 16, further comprising:
generating an output comprising a distribution of one or more offers provided to online users wherein the distribution is based on at least one of the following: customer performance score, volume, or revenue.

20. A method for receiving an online offer, comprising:
transmitting user identification information;
receiving an online offer based at least in part on a customer performance score, wherein the customer performance score comprises at least one persistence component and at least one value component, the at least one persistence component and at least one value component based at least in part on user identification information; and
transmitting an acceptance or decline of the online offer.
